(19) United States
(12) Patent Application Publication
(10) Pub. No.: US 2026/0244488 A1
(43) Pub. Date: Aug. 20, 2026

(54) DEEP LEARNING WORKLOAD SHARDING ON HETEROGENEOUS DEVICES

(71) Applicant: Intel Corporation, Santa Clara, CA (US)

(72) Inventors: Jiong Gong, Shanghai (CN); Yang Sheng, Shanghai (CN); Tong Su, Shanghai (CN); Yejun Guo, Shanghai (CN); Yiqiang Li, Shanghai (CN); Guokai Ma, Shanghai (CN); Xiao Dong Lin, Shanghai (CN)

(21) Appl. No.: 18/869,729

(22) PCT Filed: Jun. 28, 2022
(86) PCT No.: PCT/CN2022/102011

§ 371 Date: Nov. 26, 2024

(51) Int. Cl. G06F 9/48

(52) U.S. Cl. CPC G06F 9/4881

(57) ABSTRACT

The application relates to DL workload sharding on heterogeneous devices and provides a method for heterogeneous sharding of a DL workload. The method may include: converting, based on device information about a plurality of heterogeneous devices, a SD graph representing the DL workload into a MD graph including a plurality of sub-graphs that respectively represent a plurality of DL sub-workloads to be assigned to DL stages on the plurality of heterogeneous devices for completing the DL workload; and assigning the plurality of sub-graphs to respective DL stages on the plurality of heterogeneous devices.

### TECHNICAL FIELD

Embodiments described herein generally relate to deep learning (DL) networks, and more particularly relate to a method and an apparatus for DL workload sharding on heterogeneous devices.

### BACKGROUND

Ever-increasing computation demands from DL workloads motivates hardware (HW) vendors to build specialized HW acceleration units into their HW products and assemble heterogeneous HW chips (e.g. Central Processing Unit (CPU), Graph Processing Unit (GPU), Tensor Processing Unit (TPU), Application Specific Integrated Circuit (ASIC), Field Programmable Gate Array (FPGA), etc.) into a single computation node, e.g., CPU+GPU, CPU+TPU, CPU+ASIC, CPU+FPGA, etc.

### BRIEF DESCRIPTION OF THE DRAWINGS

The various advantages of the embodiments will become apparent to one skilled in the art by reading the following specification and appended claims, and by referencing the following drawings, in which:

FIG. 1 illustrates an architecture diagram of manually converting a single device (SD) program into a multi-device (MD) program with a conventional frontend Application Interface (API) provided by a DL framework;

FIG. 2 illustrates an architecture diagram of automatic DL workload sharding on homogeneous devices via graph rewrite passes in the Tensorflow DL framework;

FIG. 3 illustrates an architecture diagram of automatic DL workload sharding on heterogeneous devices via a graph rewriter called XPUAutoShard according to some embodiments of the present disclosure;

FIG. 4 illustrates an example Tensorflow Frontend Program with XPU Heterogeneous Programming according to some embodiments of the present disclosure;

FIG. 5 illustrates an example high-level graph rewrite flow of XPUAutoShard according to some embodiments of the present disclosure;

FIG. 6 illustrates an example automatic DL workload sharding on CPU and GPU with a pipeline parallel processing manner according to some embodiments of the present disclosure;

FIG. 7 illustrates an example working flow to complete heterogeneous sharding property (HSP) annotation for a SD graph with an optimization tuning loop according to some embodiments of the present disclosure;

FIG. 8 illustrates example pseudo codes to complete HSP annotation for a SD graph according to some embodiments of the present disclosure;

FIG. 9 illustrates an example algorithm for transforming a HSP-annotated SD graph to a MD graph according to some embodiments of the present disclosure;

FIG. 10 illustrates an example SD single convolution training graph according to some embodiments of the present disclosure;

FIG. 11 illustrates an example sharded single convolution training graph to be applied to one CPU having one DL stage and one GPU having two DL stages according to some embodiments of the present disclosure;

FIG. 12 illustrates an example flowchart of a procedure for heterogeneous sharding of a DL workload according to some embodiments of the present disclosure;

FIG. 13 is a block diagram illustrating components, according to some example embodiments, able to read instructions from a machine-readable or computer-readable medium and perform any one or more of the methodologies discussed herein;

FIG. 14 is a block diagram of an example processor platform in accordance with some embodiments of the disclosure.

### DETAILED DESCRIPTION

Various aspects of the illustrative embodiments will be described using terms commonly employed by those skilled in the art to convey the substance of the disclosure to others skilled in the art. However, it will be apparent to those skilled in the art that many alternate embodiments may be practiced using portions of the described aspects. For purposes of explanation, specific numbers, materials, and configurations are set forth in order to provide a thorough understanding of the illustrative embodiments. However, it will be apparent to those skilled in the art that alternate embodiments may be practiced without the specific details. In other instances, well-known features may have been omitted or simplified in order to avoid obscuring the illustrative embodiments.

Further, various operations will be described as multiple discrete operations, in turn, in a manner that is most helpful in understanding the illustrative embodiments; however, the order of description should not be construed as to imply that these operations are necessarily order dependent. In particular, these operations need not be performed in the order of presentation.

Ever-increasing computation demands from DL workloads motivates HW vendors to build specialized HW acceleration units into their HW products and assemble heterogeneous HW chips into a single computation node, e.g., CPU+GPU, CPU+ASIC, CPU+FPGA, etc.

Even though such a trend may give customers more choices to get better performance, it may also pose usability challenges about how to fully utilize these HW chips more easily. Artificial Intelligence (AI) users usually have to manually rewrite a DL program written for a single device to work on heterogeneous HW devices. The manual work would involve sharding (i.e. partitioning) a DL workload, placing the DL workload on appropriate heterogeneous HW devices, scheduling computations on individual HW devices and cross-device communication, and writing specialized compute primitives for running on the heterogeneous HW devices. For example, some DL frameworks provide frontend APIs (e.g., Horovod, PyTorch DDP, PyTorch Pipelined Execution, GraphCore Sharding) to allow users to manually convert a DL program written for a single device (i.e. a SD program) into a MD program so as to work on multiple devices via data parallel processing or pipeline parallel processing.

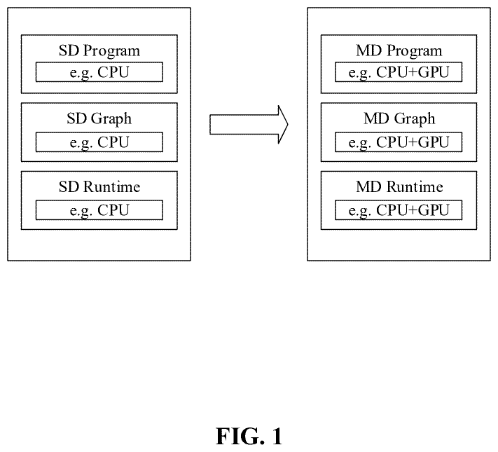

FIG. 1 illustrates an architecture diagram of manually converting a single device (SD) program into a multi-device (MD) program with a conventional frontend API provided by a DL framework. As shown in FIG. 1, for DL training, AI practitioners always start with a SD program, and the SD program is usually converted into a SD graph representation before being optimized by and executed on a device backend. The DL framework may provide frontend APIs to allow users to manually convert a SD program into a MD program. However, such a manual processing may be not practical for distributing a DL workload on heterogeneous HW devices. Given varied system architectures and connectivity speeds of the heterogeneous HW devices, achieving high efficiency from these HW devices via manual tweaking is beyond the capabilities of normal AI users.

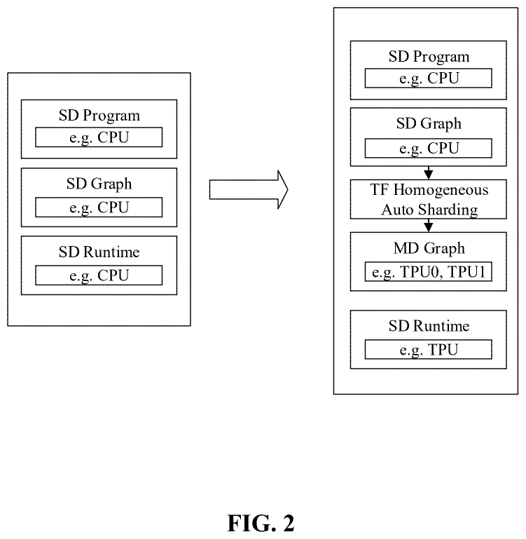

Instead of the above discussed manual processing, Tensorflow provides an automatic sharding solution via graph rewrite passes for DL models to run on multiple TPUs of the same type. FIG. 2 illustrates an architecture diagram of automatic DL workload sharding on homogeneous devices via graph rewrite passes in the Tensorflow DL framework. As shown in FIG. 2, the automatic sharding in Tensorflow is also designed for distributed training on homogeneous HW devices. Tensors in the SD graph are evenly sharded due to the fact of homogeneity, and the number of shards in the MD graph is no larger than the number of the HW devices. The automatic sharding in Tensorflow may support data parallel and model parallel on arbitrary models, but it may only support pipeline parallel on a model with repetitive patterns like a Bidirectional Encoder Representation from Transformers (BERT) encoder. In other words, the pipeline parallel processing with the automatic sharding in Tensorflow requires a strong assumption on the architecture of the DL model and thus cannot work broadly.

In addition, OpenVINO recently introduced a feature that automatically does inference on a set of heterogeneous HW devices. The solution of OpenVINO is for inference models only and does not support “multi-stage” sharding. Sharding a DL workload for a training model is more complicated than sharding a DL workload for an inference model. Specifically, more cross-device communications among sharded workloads are involved during each training iteration while sharded inference workloads per device are basically independent; more kinds of operations are involved in the training model which increase complexity; increased memory bandwidth/capacity are required by the training model due to the need of larger mini-batch size and backward computation for training which complicate the sharding algorithm.

Furthermore, gradient accumulation is a common practice to allow large-batch models to run on a device with limited memory capacity. Users explicitly change the program code to invoke forward and backward training processes multiple times before weight updating. However, the gradient accumulation requires users to manually decide how to split the batch size and the times of forward and backward training. On the other hand, in order to mitigate slow connectivity during data parallel training, people usually increase the batch size. However, increasing the batch size would make the training model harder to fit device memory and/or cache, and also impacts the convergence of models with batch normalization.

In view of these issues, an idea of automatic DL workload sharding on heterogeneous devices via a graph rewriter called XPUAutoShard is proposed in the present disclosure. The idea of automatic DL workload sharding may apply to both training related DL workloads and inference related DL workloads, and may enable either data parallel processing or pipeline parallel processing for arbitrary DL models without any assumption on model architecture.

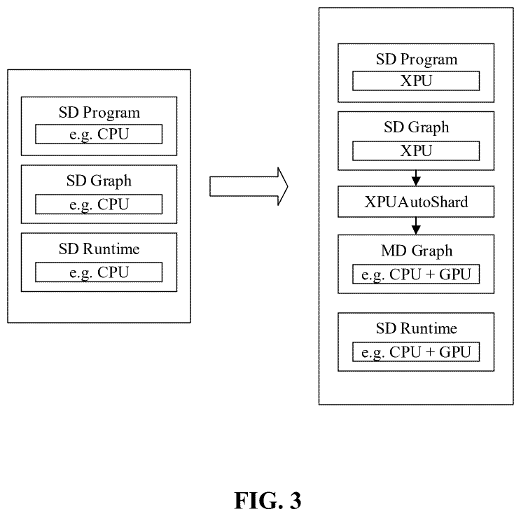

FIG. 3 illustrates an architecture diagram of automatic DL workload sharding on heterogeneous devices via XPUAutoShard according to some embodiments of the present disclosure. In the embodiments, users may run an existing single device DL program on a virtual device called XPU which represents all heterogeneous HW devices on a node for completing a DL workload corresponding to the DL program. The DL framework converts the DL program into DL computational graphs. The XPUAutoShard may automatically shard the data (i.e. tensors) and operations in the graphs into sub-graphs and place each sub-graph (with sharded data and operations) on a device. The resulting sharded graph may run on existing compute primitives written for the single device.

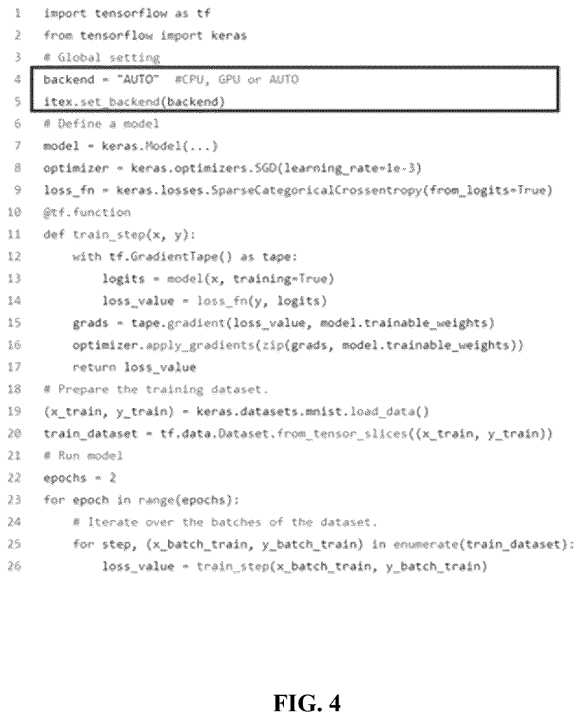

FIG. 4 illustrates an example Tensorflow Frontend Program with XPU Heterogeneous Programming according to some embodiments of the present disclosure. The program shown in FIG. 4 may be a normal SD training program that runs on the virtual XPU device (see codes in the black box for device placement), same as how the SD training program is written for CPU or GPU device. As illustrated in FIG. 3, the SD program in FIG. 4 may be firstly converted into a SD graph by the DL framework and then converted into a MD graph by the XPUAutoShard. The MD graph may include a plurality of sub-graphs that respectively represent a plurality of DL sub-workloads to be assigned to DL stages on the heterogeneous devices for completing the DL workload. It is noted that each of the heterogeneous devices may include one or more DL stages for running one or more DL sub-workloads represented by respective sub-graphs.

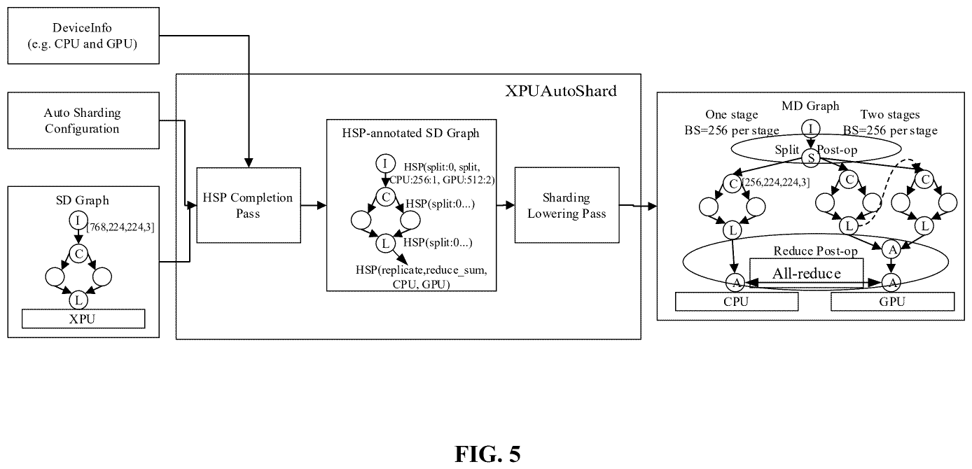

FIG. 5 illustrates an example high-level graph rewrite flow of XPUAutoShard according to some embodiments of the present disclosure. The inputs to XPUAutoShard may include a SD graph from the DL framework, device information (DeviceInfo) about a plurality of heterogeneous devices, and optional auto-sharding configuration.

In the example, the SD graph may include some input nodes (marked “I” here) and some compute nodes (marked “C” or “L” or unmarked here, “C” here represents a normal compute node, and “L” here represents a sum reduction node on all dimensions). The shapes of input tensors could be static or dynamic in each dimension. In the example, the first dimension is static and has a size of 768 bits, while the remaining dimensions are dynamic.

The DeviceInfo may describe a device type, computation capability (e.g., ops per cycle for vector/matrix compute, frequency and number of cores/Execution Units (EUs) etc.), cache capacity, latency and bandwidth, and memory capacity, latency and bandwidth of each of the plurality of heterogeneous devices, and inter-connection latency and bandwidth among the plurality of heterogeneous devices. In the example, the DeviceInfo describes information about two heterogeneous devices, i.e. CPU and GPU.

The auto-sharding configuration may include some configurations specified for an auto-sharding algorithm used in the XPUAutoShard. For example, the auto-sharding configuration may include a parallel processing manner (e.g. a data parallel processing manner or a pipeline parallel processing manner) for sharding the DL workload among the plurality of heterogeneous devices, a minimal per-stage batch size for the plurality of heterogeneous devices, and an indicator for indicating whether a per-stage batch size for each of the plurality of heterogeneous devices needs to be consistent.

It is noted that the auto-sharding configuration may be an optional input of the XPUAutoShard. That is, when no auto-sharding configuration is input to the XPUAutoShard, the XPUAutoShard may convert the SD graph into the MD graph based on the DeviceInfo and a default auto-sharding configuration predetermined for the XPUAutoShard. On the other hand, setting the auto-sharding configuration may allow the AI users to specify their preferred auto-sharding configuration options, e.g. a preferred parallel processing manner (data parallel or pipeline parallel), a preferred minimal per-stage batch size, and whether a per-stage batch size for each device should be consistent. In the example shown in FIG. 5, the parallel processing manner is a data parallel processing manner, that is, the training data is sharded and placed on each device, each device runs the training program with the sharded training data in a parallel manner, and then training results from all the devices are integrated to complete the training process.

The output of XPUAutoShard is the multi-device sharded graph. In the example, the SD graph is sharded into three parts along the batch dimension (i.e. the first dimension) with one DL stage on the CPU and two DL stages on the GPU, each stage having a batch size (BS) of 256 bits. When performing automatic sharding of a DL workload on heterogeneous HW devices that reside on a single computation node, how to guarantee DL model convergence with sharded sub-workloads may be a critical problem to be solved, especially for DL models with batch normalization where the statistical batch size has to be consistent among the heterogeneous HW devices to guarantee convergence with known hyper-parameters. In view of this problem, according to some embodiments of the present disclosure, each of the heterogeneous HW devices may include one or more DL stages for running one or more DL sub-workloads represented by respective sub-graphs. In other words, some sub-graphs in the MD graph may be a multi-stage graph, which makes a large batch size training possible with limited device memory and cache capacity and also helps the statistical batch size to be consistent for batch normalization.

For example, as shown in FIG. 5, the CPU includes one DL stage and the GPU includes two DL stages, and each DL stage starts from the normal compute node “C” and ends with the sum reduction node “L”. The operation node “S” (meaning “split”) is inserted as a post-operation (“post-op”) of the input node “I” to split the input tensor into three shards. It is noted that a control dependency (shown by the dashed-line arrow) is added from the sum reduction node “L” of the first DL stage of GPU to the normal compute node “C” of the second DL stage of GPU to make sure the second DL stage runs after the first DL stage completes, which makes sure the intermediate tensors used by one stage can be freed before the start of the other stage. Since the nodes “L” are sum reduction nodes, operation nodes “A” representing sum reduction post-ops are inserted after the nodes “L” respectively. These operation nodes “A” may apply a device-local reduction first for each device followed by an “all-reduce” collective communication among the devices.

Next, the internal configuration of the XPUAutoShard will be described in detail with further reference to FIG. 5. Inside the XPUAutoShard, the SD graph may be annotated with heterogeneous sharding property (HSP) on each tensor to generate a HSP-annotated SD graph, and the HSP-annotated SD graph may be transformed into the MD graph based on the HSP associated with each tensor in the SD graph. Specifically, as shown in FIG. 5, the “HSP Completion Pass” may annotate all the tensors in the SD graph with corresponding HSPs, and the “Sharding Lowering Pass” may mechanically rewrite the SD graph into MD graph according to the HSPs. For each tensor, the HSP may describe how each dimension of the tensor is sharded and placed on each device, and the HSP may also describe the post-op associated with the tensor.

The example in FIG. 5 shows a data parallel sharding. An example HSP for splitting dimensions of the tensor may be describe as follows:
HSP (split:<dim>,<post-op>,<device>:<size or ratio>:<num_stages>, . . . )

It is noted here that the HSP for splitting dimensions of the tensor may be configured to indicate more than one split operations and corresponding splitting dimensions. In other words, there may be multiple fields of “split:<dim>” in the HSP. Accordingly, one or more split operations along respective splitting dimensions may be performed on each tensor.

An example HSP for replicating tensors on multiple devices may be described as follows:
HSP (replicate,<post-op>,<device>, . . . )

For example, the “HSP (split:0, split, CPU:256:1, GPU:512:2)” on the output tensor of the input node “I” means to split the output tensor at the first dimension (e.g., dimension 0) and place the split tensors on the CPU having a parallel data size of 256 bits with a single stage and the GPU having a parallel data size of 512 bits with two stages, 256 bits per stage. If the tensor shape is dynamic, the “split” can also be specified with ratios, e.g., ⅓ on CPU and ⅔ on GPU. In addition, an operation node “S” representing a split post-op should be inserted after the input node “I” to apply the “split” post-op on the output tensor of the input node “I”. The “HSP (replicate, reduce_sum, CPU, GPU)” on the output tensor of “L” means to replicate the tensor on the CPU and the GPU with the “reduce_sum” post-op.

Generally, for each tensor in the SD graph, the corresponding HSP may be configured to indicate a sharding-related operation on the tensor, a post-operation associated with the tensor, and one or more DL devices where the tensor is to be placed.

The sharding-related operation on the tensor may include one or more split operations. In this case, the HSP may be configured to further indicate a splitting dimension specified for each split operation and a parameter associated with each of the one or more DL devices, and the split operation may be configured to split the tensor along the splitting dimension to place the tensor on the one or more DL devices based on the parameters associated with the DL devices. The parameter associated with each of the one or more DL devices may include a parallel data size of the DL device and a number of DL stages for running respective DL sub-workloads associated with the DL device. Alternatively, when the tensor has a dynamic tensor shape, the parameter associated with each of the one or more DL devices may include a ratio of DL sub-workloads associated with the DL device to the DL workload and a number of DL stages for running respective DL sub-workloads associated with the DL device. In addition to the split operation, the sharding-related operation on the tensor may be a replicate operation configured to replicate the tensor and place the replicated tensor on the one or more DL devices.

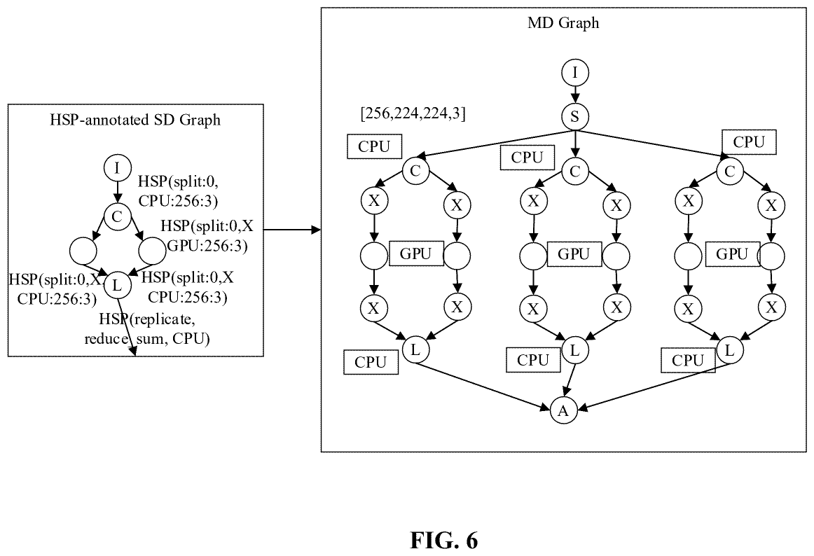

As mentioned above, the AI users may specify their preferred auto-sharding configuration, e.g. a preferred parallel processing manner (data parallel or pipeline parallel). FIG. 6 illustrates an example automatic DL workload sharding on CPU and GPU with a pipeline parallel processing manner according to some embodiments of the present disclosure. The same mechanism as that described with reference to FIG. 5 can apply to the pipeline parallel sharding in FIG. 6. As to the pipeline parallel sharding, the pipeline of the DL workload may be sharded into a plurality of layers, and the sharded DL sub-workloads corresponding to each layer may be assigned to a corresponding DL device. Also, each device may include one or more DL stages for for running one or more DL sub-workloads. In the example of FIG. 6, the input tensor is sharded into three splits to be processed by three stages of CPU, and the pipeline of the DL workload is sharded into three layers of which the sharded DL sub-workloads corresponding to the first layer and the third layer are assigned to the CPU and the sharded DL sub-workloads corresponding to the second layer are assigned to the GPU. It is noted that the operation nodes “X” representing the post-ops for CPU-to-GPU or GPU-to-CPU data movement are inserted in the MD graph.

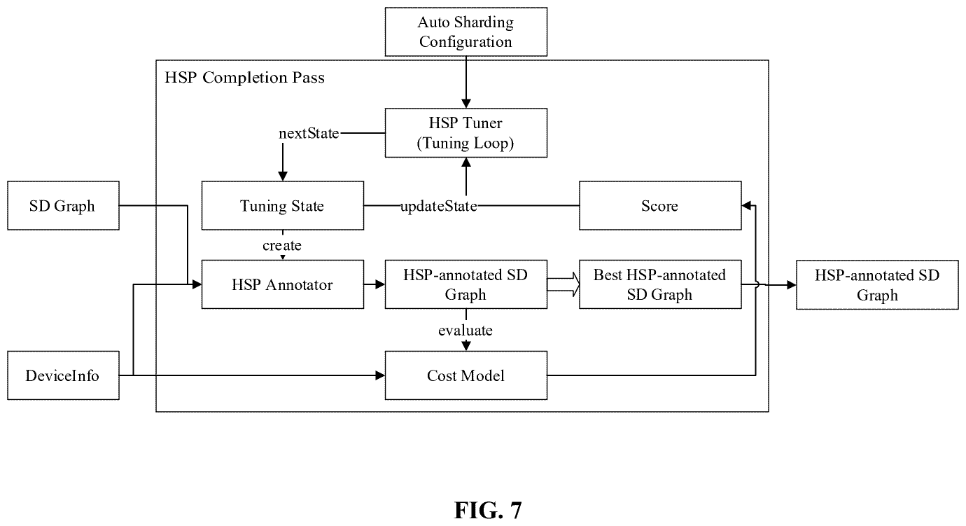

As shown in FIG. 5, the XPUAutoShard includes the HSP Completion Pass for generating the HSP-annotated SD graph and the Sharding Lowering Pass for transforming the HSP-annotated SD graph into the MD graph. The details about the HSP Completion Pass and the Sharding Lowering Pass will be further described with reference to FIG. 7 to FIG. 9.

FIG. 7 illustrates an example working flow to complete HSP annotation for a SD graph with an optimization tuning loop according to some embodiments of the present disclosure. In the embodiments, the HSP Completion Pass may follow a general optimization tuning loop to annotate HSPs to all the tensors in the SD graph. The flow of the tuning loop as shown in FIG. 7 is driven by a “HSP Tuner”. During each tuning iteration, a sharding state may be generated as the configuration for creating an “HSP Annotator” which is responsible for creating a HSP-annotated graph to be evaluated by a “Cost Model” to score a sharded graph corresponding to the sharding state. Here, the sharding state may include HSPs for the tensors in the SD graph. The “Cost Model” may be used to evaluate the computation cost of each operation in the sharded graph given the DeviceInfo, and may be implemented with an analytic model, runtime profiling, learned model or combined. Based on the score of the sharded graph, the sharding state may be tuned and the HSP-annotated SD graph may be updated, and the best HSP-annotated SD graph may be recorded as the output of the HSP Completion Pass.

To be more general, the HSP Completion Pass may annotate each tensor in the SD graph with a corresponding HSP by tuning the HSP for each tensor based on a device cost model for evaluating a computation cost of each operation to be assigned to the plurality of heterogeneous devices, and obtaining a HSP-annotated SD graph with a best computation cost score as the HSP-annotated SD graph.

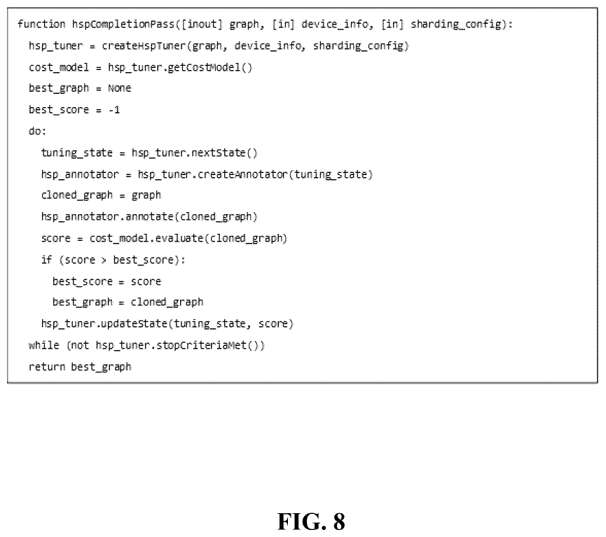

FIG. 8 illustrates example pseudo codes of the HSP Completion Pass according to some embodiments of the present disclosure. As shown in FIG. 8, a key model in the function HSP Completion Pass is the HSP tuner. The implementation choices of the HSP tuner will be described in detail below.

A direct implementation of the HSP tuner and the HSP annotator may be based on some heuristics. For the data parallel processing, the HSP tuner may use the operation semantics to decide which dimension of the input tensor is a “split” candidate and which input is a “replicate” candidate. For example, the first dimension of the data input to convolution is a batch dimension for the “split” candidate and the weight input to convolution is the “replicate” candidate. All other HSPs in the graph can be decided by propagating the HSPs throughout the graph according to the semantics of the operations, similar to the algorithm in Tensorflow automatic sharding. For example, the split ratio for a HW device may be determined according to a normalized computation capability of the HW device calculated by the following formula (w1-w5 are predefined parameters):

$${TOPS}^{w 1} \times {CacheBandwidth}^{w 2} \times {MemoryBandwidth}^{w 3} \times {CacheLatency}^{w 4} \times {MemoryLatency}^{w 5}$$

As an example, a grid search may be applied on the batch size per stage by sweeping the power of 2 values to get the best score, and the maximum allowed batch size can be calculated with the memory footprint of the graph with respect to the device memory capacity.

On the other hand, for the pipeline parallel processing, the HSP tuner may sweep the number of stages starting from the number of devices to a configured upper bound. The number of stages may determine the number of splits applied to the batch dimension. In the HSP annotator, for a given number of stages, it may be possible to order the operations with breadth-first traverse and assign the device to the operations one after another greedily, i.e., assign the device to the next operation “A” which brings the least total cost evaluated from the first operation to the operation “A”.

A more advanced implementation of the HSP tuner can rely on Graph Neural Network (GNN) as the implementation of the HSP annotator to predict the HSPs. When discretizing the parameter values in an HSP, the problem may become a node classification problem of GNN, i.e., predicting the HSP of the output tensor of an operation node. Then, by sampling the HSP solutions from GNN, the HSP tuner can identify the best score by evaluating the candidate annotations with the cost model.

In addition to the HSP Completion Pass, the XPUAutoShard further includes the Sharding Lowering Pass for transforming the HSP-annotated SD graph to the MD graph. Specifically, transforming the HSP-annotated SD graph into the MD graph may include splitting the HSP-annotated SD graph into the plurality of sub-graphs based on the sharding-related operation specified in the HSP on each tensor in the SD graph and inserting an operation node corresponding to the post-operation associated with each tensor in the SD graph. In addition, when a DL device where a tensor is to be placed includes two or more DL stages, transforming the HSP-annotated SD graph into the MD graph may further include adding a control dependency from an ending operation node of one DL stage of the DL device to a beginning operation node of a next DL stage of the DL device.

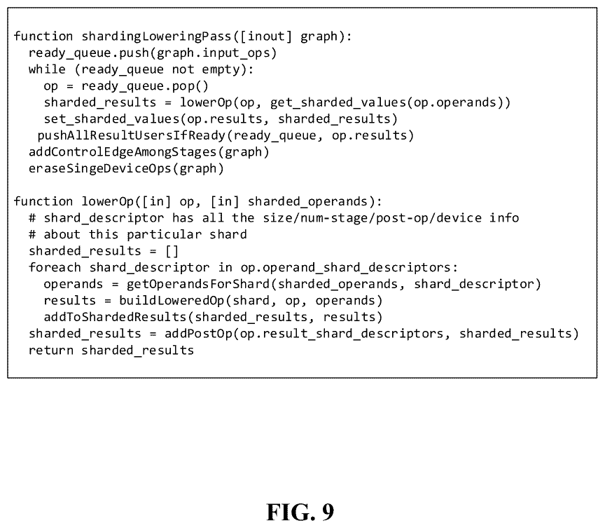

FIG. 9 illustrates an example algorithm for transforming a HSP-annotated SD graph to a MD graph according to some embodiments of the present disclosure. The Sharding Lowering Pass may mechanically transform a HSP-annotated SD graph into a MD graph with the example algorithm shown in FIG. 9. In the algorithm, the function “addControlEdgeAmongStages” may add a control dependency from an ending operation node of a “split” region in one stage of a DL device to a beginning operation node of a “split” region in the next stage of the same device. For brevity, details of functions with straightforward implementation are ignored.

The idea of automatic DL workload sharding on heterogeneous devices via XPUAutoShard according to the embodiments of the present disclosure has been described above with reference to FIG. 3 to FIG. 9. On the basis of the detailed description, it can be easily understood that the automatic DL workload sharding via XPUAutoShard may apply to both training related DL workloads and inference related DL workloads, and may enable either data parallel processing or pipeline parallel processing for arbitrary DL models without any assumption on model architecture. The XPUAutoShard can automatically decide which dimensions of the tensors to shard and what devices to place the sharded tensors according to some heuristics and a device cost model. Based on the proposed automatic DL workload sharding, each device can work on more than one data shards and process the sharded sub-graphs with multiple DL stages. In addition, the sizes of shards and/or the number of stages could be uneven for work balancing among heterogeneous HW devices, and a per-stage size of each shard can be set according to the device cost model to fit device memory and/or maximize cache residency of the heterogeneous HW devices, and also to guarantee convergence of models with batch normalization.

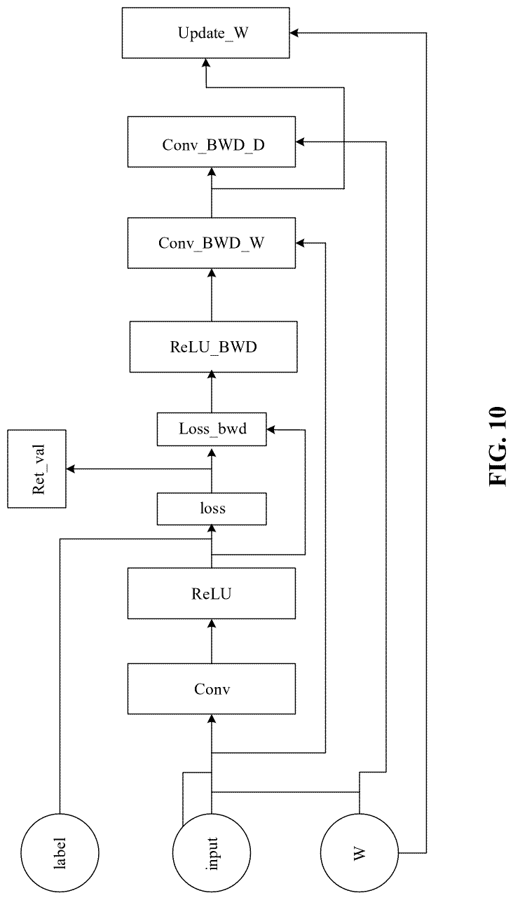

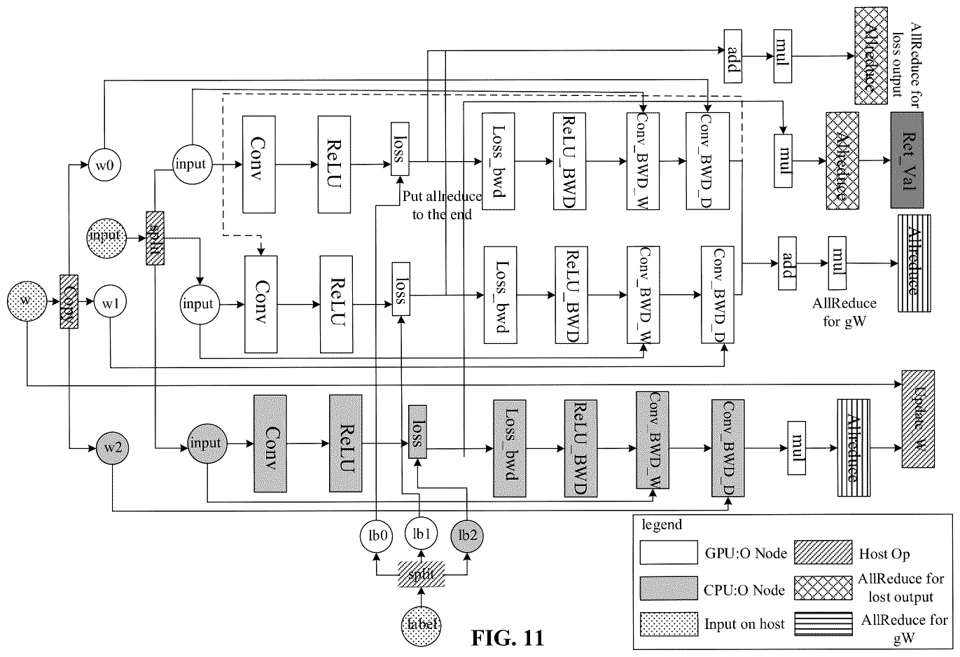

To further illustrate the proposed solution for automatic DL workload sharding on heterogeneous devices, a real example of sharding a single convolution training workload on CPU and GPU will be demonstrated in FIG. 10 and FIG. 11. FIG. 10 illustrates an example SD single convolution training graph according to some embodiments of the present disclosure, and FIG. 11 illustrates an example sharded single convolution training graph to be applied to one CPU having one DL stage and one GPU having two DL stages according to some embodiments of the present disclosure. As illustrated by FIG. 10 and FIG. 11, the SD single convolution training graph has been transformed into a sharded single convolution training graph to be processed by one DL stage on the CPU and two DL stages on the GPU based on a data parallel processing manner. As shown in FIG. 11, the training data (including the input data and the label) is sharded into three parts and placed on three DL stages on CPU and GPU, each DL stage runs the single convolution training with the sharded training data in a parallel manner, and then training results from all the DL stages are integrated to complete the training process.

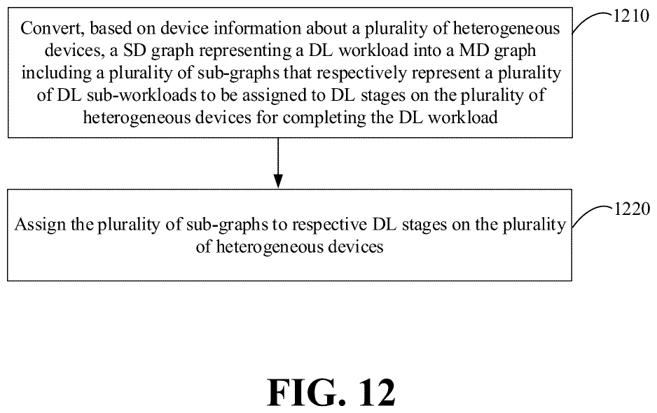

For better understanding an overall solution for heterogeneous sharding of a DL workload proposed in the disclosure, the proposed heterogeneous DL workload sharding approach will be further described with reference to the flowchart shown in FIG. 12.

FIG. 12 illustrates an example flowchart of a procedure for heterogeneous sharding of a DL workload according to some embodiments of the present disclosure. The procedure for heterogeneous sharding of a DL workload may be implemented by a processor circuitry and may include operations 1210 to 1220.

At operation 1210, the processor circuitry may convert, based on device information about a plurality of heterogeneous devices, a SD graph representing the DL workload into a multiple device MD graph including a plurality of sub-graphs that respectively represent a plurality of DL sub-workloads to be assigned to DL stages on the plurality of heterogeneous devices for completing the DL workload.

According to some embodiments, each of the plurality of heterogeneous devices may include one or more DL stages for running one or more DL sub-workloads represented by respective sub-graphs.

At operation 1220, the processor circuitry may assign the plurality of sub-graphs to respective DL stages on the plurality of heterogeneous devices.

According to some embodiments, the device information may include at least one of a device type, computation capability, cache capacity, latency and bandwidth, and memory capacity, latency and bandwidth of each of the plurality of heterogeneous devices, and interconnection latency and bandwidth among the plurality of heterogeneous devices.

According to some embodiments, converting the SD graph into the MD graph may be based on the device information and an auto-sharding configuration.

According to some embodiments, the auto-sharding configuration may include a parallel processing manner for sharding the DL workload among the plurality of heterogeneous devices. The parallel processing manner may include a data parallel processing manner or a pipeline parallel processing manner.

According to some embodiments, the auto-sharding configuration may include a minimal per-stage batch size for the plurality of heterogeneous devices.

According to some embodiments, the auto-sharding configuration may include an indicator for indicating whether a per-stage batch size for each of the plurality of heterogeneous devices needs to be consistent.

According to some embodiments, the DL workload may include a training related DL workload or an inference related DL workload.

According to some embodiments, converting the SD graph into the MD graph may include: annotating each tensor in the SD graph with a corresponding heterogeneous sharding property (HSP) to generate a HSP-annotated SD graph; and transforming the HSP-annotated SD graph into the MD graph based on the HSP associated with each tensor in the SD graph.

According to some embodiments, for each tensor, the corresponding HSP may be configured to indicate at least one of a sharding-related operation on the tensor, a post-operation associated with the tensor, and one or more DL devices where the tensor is to be placed, wherein the DL devices are selected from the plurality of heterogeneous devices.

According to some embodiments, the sharding-related operation on the tensor may include one or more split operations, the HSP may be configured to further indicate a splitting dimension specified for each split operation and a parameter associated with each of the one or more DL devices, and the split operation may be configured to split the tensor along the splitting dimension to place the tensor on the one or more DL devices based on the parameters associated with the DL devices.

According to some embodiments, the parameter associated with each of the one or more DL devices may include a parallel data size of the DL device and a number of DL stages for running respective DL sub-workloads associated with the DL device.

According to some embodiments, under a condition that the tensor has a dynamic tensor shape, the parameter associated with each of the one or more DL devices may include a ratio of DL sub-workloads associated with the DL device to the DL workload and a number of DL stages for running respective DL sub-workloads associated with the DL device.

According to some embodiments, the sharding-related operation on the tensor may include a replicate operation configured to replicate the tensor and place the replicated tensor on the one or more DL devices.

According to some embodiments, transforming the HSP-annotated SD graph into the MD graph may include splitting the HSP-annotated SD graph into the plurality of sub-graphs based on the sharding-related operation on each tensor in the SD graph and inserting an operation node corresponding to the post-operation associated with each tensor in the SD graph.

According to some embodiments, under a condition that a DL device where the tensor is to be placed includes two or more DL stages for running respective two or more DL sub-workloads, transforming the HSP-annotated SD graph into the MD graph may further include adding a control dependency from an ending operation node of one DL stage of the DL device to a beginning operation node of a next DL stage of the DL device.

According to some embodiments, annotating each tensor in the SD graph with a corresponding HSP may include tuning the HSP for each tensor based on a device cost model for evaluating a computation cost of each operation to be assigned to the plurality of heterogeneous devices, and obtaining a HSP-annotated SD graph with a best computation cost score as the HSP-annotated SD graph.

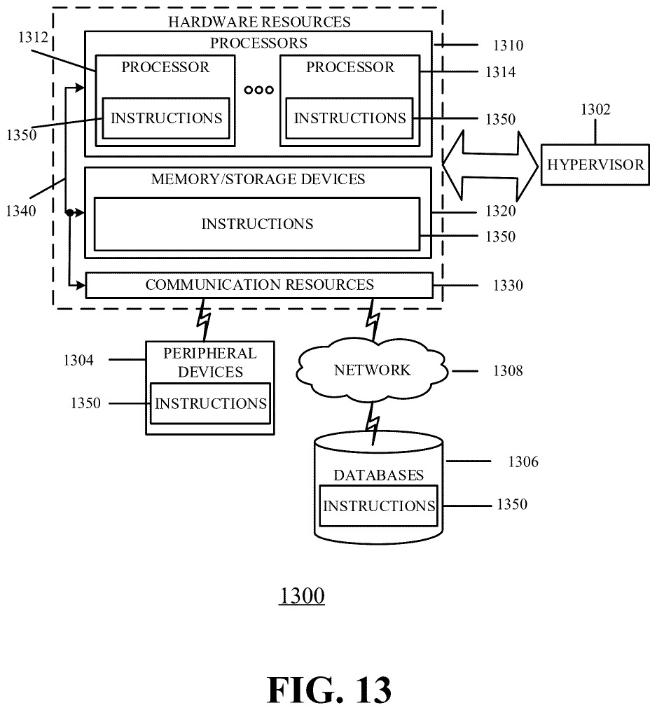

FIG. 13 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 13 shows a diagrammatic representation of hardware resources 1300 including one or more processors (or processor cores) 1310, one or more memory/storage devices 1320, and one or more communication resources 1330, each of which may be communicatively coupled via a bus 1340. For embodiments where node virtualization (e.g., NFV) is utilized, a hypervisor 1302 may be executed to provide an execution environment for one or more network slices/sub-slices to utilize the hardware resources 1300.

The processors 1310 may include, for example, a processor 1312 and a processor 1314 which may be, e.g., a central processing unit (CPU), a graphics processing unit (GPU), a tensor processing unit (TPU), a visual processing unit (VPU), a field programmable gate array (FPGA), or any suitable combination thereof.

The memory/storage devices 1320 may include main memory, disk storage, or any suitable combination thereof. The memory/storage devices 1320 may include, but are not limited to any type of volatile or non-volatile memory such as dynamic random access memory (DRAM), static random-access memory (SRAM), erasable programmable read-only memory (EPROM), electrically erasable programmable read-only memory (EEPROM), Flash memory, solid-state storage, etc.

The communication resources 1330 may include interconnection or network interface components or other suitable devices to communicate with one or more peripheral devices 1304 or one or more databases 1306 via a network 1308. For example, the communication resources 1330 may include wired communication components (e.g., for coupling via a Universal Serial Bus (USB)), cellular communication components, NFC components, Bluetooth® components (e.g., Bluetooth® Low Energy), Wi-Fi® components, and other communication components.

Instructions 1350 may comprise software, a program, an application, an applet, an app, or other executable code for causing at least any of the processors 1310 to perform any one or more of the methodologies discussed herein. The instructions 1350 may reside, completely or partially, within at least one of the processors 1310 (e.g., within the processor's cache memory), the memory/storage devices 1320, or any suitable combination thereof. Furthermore, any portion of the instructions 1350 may be transferred to the hardware resources 1300 from any combination of the peripheral devices 1304 or the databases 1306. Accordingly, the memory of processors 1310, the memory/storage devices 1320, the peripheral devices 1304, and the databases 1306 are examples of computer-readable and machine-readable media.

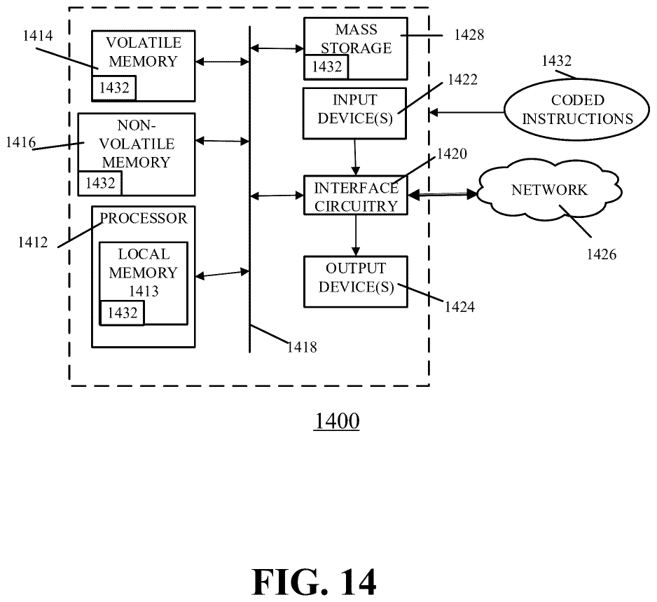

FIG. 14 is a block diagram of an example processor platform in accordance with some embodiments of the disclosure. The processor platform 1400 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset or other wearable device, or any other type of computing device.

The processor platform 1400 of the illustrated example includes a processor 1412. The processor 1412 of the illustrated example is hardware. For example, the processor 1412 can be implemented by one or more integrated circuits, logic circuits, microprocessors, GPUs, DSPs, or controllers from any desired family or manufacturer. The hardware processor may be a semiconductor based (e.g., silicon based) device. In some embodiments, the processor implements one or more of the methods or processes described above.

The processor 1412 of the illustrated example includes a local memory 1413 (e.g., a cache). The processor 1412 of the illustrated example is in communication with a main memory including a volatile memory 1414 and a non-volatile memory 1416 via a bus 1418. The volatile memory 1414 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 1416 may be implemented by flash memory and/or any other desired type of memory device. Access to the main memory 1414, 1416 is controlled by a memory controller.

The processor platform 1400 of the illustrated example also includes interface circuitry 1420. The interface circuitry 1420 may be implemented by any type of interface standard, such as an Ethernet interface, a universal serial bus (USB), a Bluetooth® interface, a near field communication (NFC) interface, and/or a PCI express interface.

In the illustrated example, one or more input devices 1422 are connected to the interface circuitry 1420. The input device(s) 1422 permit(s) a user to enter data and/or commands into the processor 1412. The input device(s) can be implemented by, for example, an audio sensor, a microphone, a camera (still or video), a keyboard, a button, a mouse, a touchscreen, a track-pad, a trackball, and/or a voice recognition system.

One or more output devices 1424 are also connected to the interface circuitry 1420 of the illustrated example. The output devices 1424 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The interface circuitry 1420 of the illustrated example, thus, typically includes a graphics driver card, a graphics driver chip and/or a graphics driver processor.

The interface circuitry 1420 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 1426. The communication can be via, for example, an Ethernet connection, a digital subscriber line (DSL) connection, a telephone line connection, a coaxial cable system, a satellite system, a line-of-site wireless system, a cellular telephone system, etc.

For example, the interface circuitry 1420 may include a training dataset inputted through the input device(s) 1422 or retrieved from the network 1426.

The processor platform 1400 of the illustrated example also includes one or more mass storage devices 1428 for storing software and/or data. Examples of such mass storage devices 1428 include floppy disk drives, hard drive disks, compact disk drives, Blu-ray disk drives, redundant array of independent disks (RAID) systems, and digital versatile disk (DVD) drives.

Machine executable instructions 1432 may be stored in the mass storage device 1428, in the volatile memory 1414, in the non-volatile memory 1416, and/or on a removable non-transitory computer readable storage medium such as a CD or DVD.

### ADDITIONAL NOTES AND EXAMPLES

Example 1 includes an apparatus for heterogeneous sharding of a Deep Learning (DL) workload, comprising: interface circuitry; and processor circuitry coupled to the interface circuitry and configured to: convert, based on device information about a plurality of heterogeneous devices received via the interface circuitry, a single device (SD) graph representing the DL workload into a multiple device (MD) graph including a plurality of sub-graphs that respectively represent a plurality of DL sub-workloads to be assigned to DL stages on the plurality of heterogeneous devices for completing the DL workload; and assign the plurality of sub-graphs to respective DL stages on the plurality of heterogeneous devices.

Example 2 includes the apparatus of Example 1, wherein the device information comprises at least one of a device type, computation capability, cache capacity, latency and bandwidth, and memory capacity, latency and bandwidth of each of the plurality of heterogeneous devices, and interconnection latency and bandwidth among the plurality of heterogeneous devices.

Example 3 includes the apparatus of Example 1 or 2, wherein the processor circuitry is configured to convert the SD graph into the MD graph based on the device information and an auto-sharding configuration received via the interface circuitry.

Example 4 includes the apparatus of Example 3, wherein the auto-sharding configuration comprises a parallel processing manner for sharding the DL workload among the plurality of heterogeneous devices.

Example 5 includes the apparatus of Example 4, wherein the parallel processing manner comprises a data parallel processing manner or a pipeline parallel processing manner.

Example 6 includes the apparatus of any of Examples 3 to 5, wherein the auto-sharding configuration comprises a minimal per-stage batch size for the plurality of heterogeneous devices.

Example 7 includes the apparatus of any of Examples 3 to 6, wherein the auto-sharding configuration comprises an indicator for indicating whether a per-stage batch size for each of the plurality of heterogeneous devices needs to be consistent.

Example 8 includes the apparatus of any of Examples 1 to 7, wherein the DL workload comprises a training related DL workload or an inference related DL workload.

Example 9 includes the apparatus of any of Examples 1 to 8, wherein the processor circuitry is configured to convert the SD graph into the MD graph by: annotating each tensor in the SD graph with a corresponding heterogeneous sharding property (HSP) to generate a HSP-annotated SD graph; and transforming the HSP-annotated SD graph into the MD graph based on the HSP associated with each tensor in the SD graph.

Example 10 includes the apparatus of Example 9, wherein for each tensor, the corresponding HSP is configured to indicate at least one of a sharding-related operation on the tensor, a post-operation associated with the tensor, and one or more DL devices where the tensor is to be placed, wherein the DL devices are selected from the plurality of heterogeneous devices.

Example 11 includes the apparatus of Example 10, wherein the sharding-related operation on the tensor comprises one or more split operations, the HSP is configured to further indicate a splitting dimension specified for each split operation and a parameter associated with each of the one or more DL devices, and the split operation is configured to split the tensor along the splitting dimension to place the tensor on the one or more DL devices based on the parameters associated with the DL devices.

Example 12 includes the apparatus of Example 11, wherein the parameter associated with each of the one or more DL devices comprises a parallel data size of the DL device and a number of DL stages for running respective DL sub-workloads associated with the DL device.

Example 13 includes the apparatus of Example 11, wherein under a condition that the tensor has a dynamic tensor shape, the parameter associated with each of the one or more DL devices comprises a ratio of DL sub-workloads associated with the DL device to the DL workload and a number of DL stages for running respective DL sub-workloads associated with the DL device.

Example 14 includes the apparatus of Example 10, wherein the sharding-related operation on the tensor comprises a replicate operation configured to replicate the tensor and place the replicated tensor on the one or more DL devices.

Example 15 includes the apparatus of any of Examples 10 to 14, wherein transforming the HSP-annotated SD graph into the MD graph comprises splitting the HSP-annotated SD graph into the plurality of sub-graphs based on the sharding-related operation on each tensor in the SD graph and inserting an operation node corresponding to the post-operation associated with each tensor in the SD graph.

Example 16 includes the apparatus of Example 15, wherein under a condition that a DL device where the tensor is to be placed includes two or more DL stages for running respective two or more DL sub-workloads, transforming the HSP-annotated SD graph into the MD graph further comprises adding a control dependency from an ending operation node of one DL stage of the DL device to a beginning operation node of a next DL stage of the DL device.

Example 17 includes the apparatus of any of Examples 9 to 16, wherein annotating each tensor in the SD graph with a corresponding HSP comprises tuning the HSP for each tensor based on a device cost model for evaluating a computation cost of each operation to be assigned to the plurality of heterogeneous devices, and obtaining a HSP-annotated SD graph with a best computation cost score as the HSP-annotated SD graph.

Example 18 includes a method for heterogeneous sharding of a Deep Learning (DL) workload, comprising: converting, based on device information about a plurality of heterogeneous devices, a single device (SD) graph representing the DL workload into a multiple device (MD) graph including a plurality of sub-graphs that respectively represent a plurality of DL sub-workloads to be assigned to DL stages on the plurality of heterogeneous devices for completing the DL workload; and assigning the plurality of sub-graphs to respective DL stages on the plurality of heterogeneous devices.

Example 19 includes the method of Example 18, wherein the device information comprises at least one of a device type, computation capability, cache capacity, latency and bandwidth, and memory capacity, latency and bandwidth of each of the plurality of heterogeneous devices, and interconnection latency and bandwidth among the plurality of heterogeneous devices.

Example 20 includes the method of Example 18 or 19, wherein converting the SD graph into the MD graph is based on the device information and an auto-sharding configuration.

Example 21 includes the method of Example 20, wherein the auto-sharding configuration comprises a parallel processing manner for sharding the DL workload among the plurality of heterogeneous devices.

Example 22 includes the method of Example 21, wherein the parallel processing manner comprises a data parallel processing manner or a pipeline parallel processing manner.

Example 23 includes the method of any of Examples 20 to 22, wherein the auto-sharding configuration comprises a minimal per-stage batch size for the plurality of heterogeneous devices.

Example 24 includes the method of any of Examples 20 to 23, wherein the auto-sharding configuration comprises an indicator for indicating whether a per-stage batch size for each of the plurality of heterogeneous devices needs to be consistent.

Example 25 includes the method of any of Examples 18 to 24, wherein the DL workload comprises a training related DL workload or an inference related DL workload.

Example 26 includes the method of any of Examples 18 to 25, wherein converting the SD graph into the MD graph comprises: annotating each tensor in the SD graph with a corresponding heterogeneous sharding property (HSP) to generate a HSP-annotated SD graph; and transforming the HSP-annotated SD graph into the MD graph based on the HSP associated with each tensor in the SD graph.

Example 27 includes the method of Example 26, wherein for each tensor, the corresponding HSP is configured to indicate at least one of a sharding-related operation on the tensor, a post-operation associated with the tensor, and one or more DL devices where the tensor is to be placed, wherein the DL devices are selected from the plurality of heterogeneous devices.

Example 28 includes the method of Example 27, wherein the sharding-related operation on the tensor comprises one or more split operations, the HSP is configured to further indicate a splitting dimension specified for each split operation and a parameter associated with each of the one or more DL devices, and the split operation is configured to split the tensor along the splitting dimension to place the tensor on the one or more DL devices based on the parameters associated with the DL devices.

Example 29 includes the method of Example 28, wherein the parameter associated with each of the one or more DL devices comprises a parallel data size of the DL device and a number of DL stages for running respective DL sub-workloads associated with the DL device.

Example 30 includes the method of Example 28, wherein under a condition that the tensor has a dynamic tensor shape, the parameter associated with each of the one or more DL devices comprises a ratio of DL sub-workloads associated with the DL device to the DL workload and a number of DL stages for running respective DL sub-workloads associated with the DL device.

Example 31 includes the method of Example 27, wherein the sharding-related operation on the tensor comprises a replicate operation configured to replicate the tensor and place the replicated tensor on the one or more DL devices.

Example 32 includes the method of any of Examples 27 to 31, wherein transforming the HSP-annotated SD graph into the MD graph comprises splitting the HSP-annotated SD graph into the plurality of sub-graphs based on the sharding-related operation on each tensor in the SD graph and inserting an operation node corresponding to the post-operation associated with each tensor in the SD graph.

Example 33 includes the method of Example 32, wherein under a condition that a DL device where the tensor is to be placed includes two or more DL stages for running respective two or more DL sub-workloads, transforming the HSP-annotated SD graph into the MD graph further comprises adding a control dependency from an ending operation node of one DL stage of the DL device to a beginning operation node of a next DL stage of the DL device.

Example 34 includes the method of any of Examples 26 to 33, wherein annotating each tensor in the SD graph with a corresponding HSP comprises tuning the HSP for each tensor based on a device cost model for evaluating a computation cost of each operation to be assigned to the plurality of heterogeneous devices, and obtaining a HSP-annotated SD graph with a best computation cost score as the HSP-annotated SD graph.

Example 35 includes a computer-readable medium having instructions stored thereon, wherein the instructions, when executed by processor circuitry, cause the processor circuitry to perform the method of any of Examples 18 to 34.

Example 36 includes a device for heterogeneous sharding of a Deep Learning (DL) workload, comprising means for performing the method of any of Examples 18 to 34.

Various techniques, or certain aspects or portions thereof, may take the form of program code (i.e., instructions) embodied in tangible media, such as floppy diskettes, CD-ROMs, hard drives, non-transitory computer readable storage medium, or any other machine-readable storage medium, wherein, when the program code is loaded into and executed by a machine, such as a computer, the machine becomes an apparatus for practicing the various techniques. The non-transitory computer readable storage medium may be a computer readable storage medium that does not include signal. In the case of program code execution on programmable computers, the computing system may include a processor, a storage medium readable by the processor (including volatile and non-volatile memory and/or storage elements), at least one input device, and at least one output device. The volatile and non-volatile memory and/or storage elements may be a RAM, EPROM, flash drive, optical drive, magnetic hard drive, solid state drive, or other medium for storing electronic data. One or more programs that may implement or utilize the various techniques described herein may use an application programming interface (API), reusable controls, and the like. Such programs may be implemented in a high level procedural or object oriented programming language to communicate with a computer system. However, the program(s) may be implemented in assembly or machine language, if desired. In any case, the language may be a compiled or interpreted language, and combined with hardware implementations. Exemplary systems or devices may include without limitation, laptop computers, tablet computers, desktop computers, smart phones, computer terminals and servers, storage databases, and other electronics which utilize circuitry and programmable memory, such as household appliances, smart televisions, digital video disc (DVD) players, heating, ventilating, and air conditioning (HVAC) controllers, light switches, and the like.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

The invention claimed is:

1-25. (canceled)

26. An apparatus for heterogeneous sharding of a Deep Learning (DL) workload, the apparatus comprising:
interface circuitry;
computer readable instructions; and
at least one processor circuit to be programmed based on the computer readable instructions to:
convert, based on device information corresponding to a plurality of heterogeneous devices, a single device (SD) graph representing the DL workload into a multiple device (MD) graph, the MD graph including a plurality of sub-graphs that respectively represent a plurality of DL sub-workloads to be assigned to DL stages on the plurality of heterogeneous devices for completing the DL workload, the device information obtained via the interface circuitry; and
assign the plurality of sub-graphs to respective DL stages on the plurality of heterogeneous devices.

27. The apparatus of claim 26, wherein one or more of the at least one processor circuit is to convert the SD graph into the MD graph based on the device information and an auto-sharding configuration obtained via the interface circuitry.

28. The apparatus of claim 27, wherein the auto-sharding configuration includes a parallel processing manner for sharding the DL workload among the plurality of heterogeneous devices.

29. The apparatus of claim 27, wherein the auto-sharding configuration includes a minimal per-stage batch size for the plurality of heterogeneous devices.

30. The apparatus of claim 26, wherein one or more of the at least one processor circuit is to convert the SD graph into the MD graph by:
annotating a tensor in the SD graph with a corresponding heterogeneous sharding property (HSP) to generate an HSP-annotated SD graph; and
transforming the HSP-annotated SD graph into the MD graph based on the HSP associated with the tensor in the SD graph.

31. The apparatus of claim 30, wherein the corresponding HSP is to indicate at least one of a sharding-related operation on the tensor, a post-operation associated with the tensor, or one or more DL devices where the tensor is to be placed, the one or more DL devices selected from the plurality of heterogeneous devices.

32. The apparatus of claim 31, wherein the sharding-related operation on the tensor includes one or more split operations, the HSP is to further indicate a splitting dimension specified for a split operation and parameters associated with the one or more DL devices, and the split operation is to split the tensor along the splitting dimension to place the tensor on the one or more DL devices based on the parameters associated with the one or more DL devices.

33. The apparatus of claim 32, wherein a first one of the parameters associated with a first DL device of the one or more DL devices includes a parallel data size of the first DL device and a number of DL stages for running respective DL sub-workloads associated with the first DL device.

34. The apparatus of claim 32, wherein under a condition that the tensor has a dynamic tensor shape, a first one of the parameters associated with a first DL device of the one or more DL devices includes a ratio of DL sub-workloads associated with the first DL device to the DL workload and a number of DL stages for running respective DL sub-workloads associated with the first DL device.

35. The apparatus of claim 31, wherein the sharding-related operation on the tensor includes a replicate operation configured to replicate the tensor and place the replicated tensor on the one or more DL devices.

36. The apparatus of claim 31, wherein one or more of the at least one processor circuit is to transform the HSP-annotated SD graph into the MD graph by:
splitting the HSP-annotated SD graph into the plurality of sub-graphs based on the sharding-related operation on each tensor in the SD graph; and
inserting an operation node corresponding to the post-operation associated with each tensor in the SD graph.

37. The apparatus of claim 36, wherein under a condition that a first DL device of the one or more DL devices where the tensor is to be placed includes two or more DL stages for running respective two or more DL sub-workloads, one or more of the at least one processor circuit is to transform the HSP-annotated SD graph into the MD graph by adding a control dependency from an ending operation node of one DL stage of the first DL device to a beginning operation node of a next DL stage of the first DL device.

38. A method for heterogeneous sharding of a Deep Learning (DL) workload, the comprising:
converting, based on device information corresponding to a plurality of heterogeneous devices, a single device (SD) graph representing the DL workload into a multiple device (MD) graph, the MD graph including a plurality of sub-graphs that respectively represent a plurality of DL sub-workloads to be assigned to DL stages on the plurality of heterogeneous devices for completing the DL workload; and
assigning the plurality of sub-graphs to respective DL stages on the plurality of heterogeneous devices.

39. The method of claim 38, wherein the device information includes at least one of a device type, computation capability, cache capacity, memory capacity, latency and bandwidth of ones of the plurality of heterogeneous devices, or interconnection latency and bandwidth among the plurality of heterogeneous devices.

40. The method of claim 38, wherein the converting of the SD graph into the MD graph includes:
annotating each tensor in the SD graph with a corresponding heterogeneous sharding property (HSP) to generate an HSP-annotated SD graph; and
transforming the HSP-annotated SD graph into the MD graph based on the HSP associated with each tensor in the SD graph.

41. The method of claim 40, wherein for each tensor, the corresponding HSP is to indicate at least one of a sharding-related operation on the tensor, a post-operation associated with the tensor, or one or more DL devices where the tensor is to be placed, the one or more DL devices selected from the plurality of heterogeneous devices.

42. The method of claim 41, wherein transforming of the HSP-annotated SD graph into the MD graph includes:
splitting the HSP-annotated SD graph into the plurality of sub-graphs based on the sharding-related operation on each tensor in the SD graph; and
inserting an operation node corresponding to the post-operation associated with each tensor in the SD graph.

43. The method of claim 42, wherein under a condition that a first DL device one or more DL devices where the tensor is to be placed includes two or more DL stages for running respective two or more DL sub-workloads, the transforming of the HSP-annotated SD graph into the MD graph includes adding a control dependency from an ending operation node of one DL stage of the first DL device to a beginning operation node of a next DL stage of the first DL device.

44. The method of claim 40, wherein the annotating of each tensor in the SD graph with a corresponding HSP includes:
tuning the corresponding HSP for each tensor based on a device cost model for evaluating a computation cost of each operation to be assigned to the plurality of heterogeneous devices; and
obtaining an HSP-annotated SD graph with a best computation cost score as the HSP-annotated SD graph.

45. A computer-readable medium comprising computer-readable instructions to cause one or more processor circuits to at least:
convert, based on device information corresponding to a plurality of heterogeneous devices, a single device (SD) graph representing a Deep Learning (DL) workload into a multiple device (MD) graph, the MD graph including a plurality of sub-graphs that respectively represent a plurality of DL sub-workloads to be assigned to DL stages on the plurality of heterogeneous devices for completing the DL workload; and
assign the plurality of sub-graphs to respective DL stages on the plurality of heterogeneous devices.
